(19) United States
(12) Patent Application Publication
(10) Pub. No.: US 2012/0162137 A1
(43) Pub. Date: Jun. 28, 2012

(54) ELECTRONIC DEVICE WITH TOUCH INPUT FUNCTION

(75) Inventor: SONG-LING YANG, Shenzhen (CN)

(73) Assignees: HON HAI PRECISION INDUSTRY CO.LTD., Tu-Cheng (TW); HONG FU JIN PRECISION INDUSTRY (ShenZhen)CO., LTD., Shenzhen City (CN)

(21) Appl. No.: 13/155,394

(22) Filed: Jun. 8, 2011

(30) Foreign Application Priority Data
Dec. 24, 2010 (CN) 201010604404.3

(51) Int. Cl. G06F 3/042

(52) U.S. Cl. 345/175

(57) ABSTRACT

The present disclosure provides an electronic device with touch input function. The device includes a display, a processor, and an infrared controlling module arranged in the frame of the display. The controlling module includes a quadrant-shaped main body with an arc sidewall perpendicular to the surface of the display. At least one infrared module, including a vertically separated emitter and receiver, is disposed at the sidewall. The emitter emits infrared rays substantially in a plane or curtain which is perpendicular to the display and the sidewall respectively. One infrared ray may be blocked and reflected by an object to the infrared receiver when the object touches the screen and the processor determines by triangulation the spot which has been touched.

### BACKGROUND

1. Technical Field

The present disclosure relates to electronic devices and, more particularly, to an electronic device having a touch input function.

2. Description of Related Art

Nowadays, electronic devices equipped with touch panels are very popular. Infrared matrix type touch panels are commonly used. A conventional infrared matrix type touch panel has horizontal and vertical infrared emission and detection arrays that are arranged on four sides of the panel to produce infrared rays in the shape of very close columns and rows on the panel. When an object touches a spot on the panel, the object blocks an infrared ray passing through the touched spot, and the positional information of the touched spot is determined by detecting which infrared ray is blocked. However, in conventional infrared matrix type touch panels, the emitters and detectors are arranged on all four sides of the panel, which causes unnecessary complexity and expense in the panel.

Therefore, it is desirable to provide an electronic device with infrared touch panels, which can overcome the above-mentioned limitations.

### BRIEF DESCRIPTION OF THE DRAWINGS

The components in the drawings are not necessarily drawn to scale, the emphasis instead being placed upon clearly illustrating the principles of the present disclose. Moreover, in the drawings, like reference numerals designate corresponding parts throughout the several views.

FIG. 1 is a schematic view showing an electronic device with a touch input function, in accordance with an exemplary embodiment.

FIG. 2 is a schematic view showing an infrared controlling module of the electronic device of FIG. 1.

FIG. 3 is a schematic view showing how to determine a spot on the display of the electronic device of FIG. 1 which has been touched.

### DETAILED DESCRIPTION

The disclosure is illustrated by way of example and not by way of limitation. It should be noted that references to “an” or “one” embodiment in this disclosure are not necessarily to the same embodiment, and such references mean at least one.

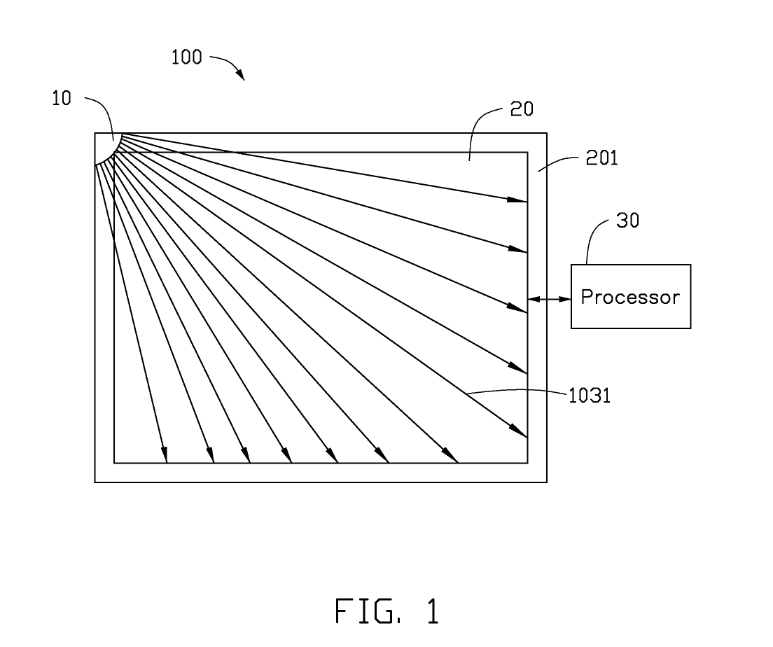

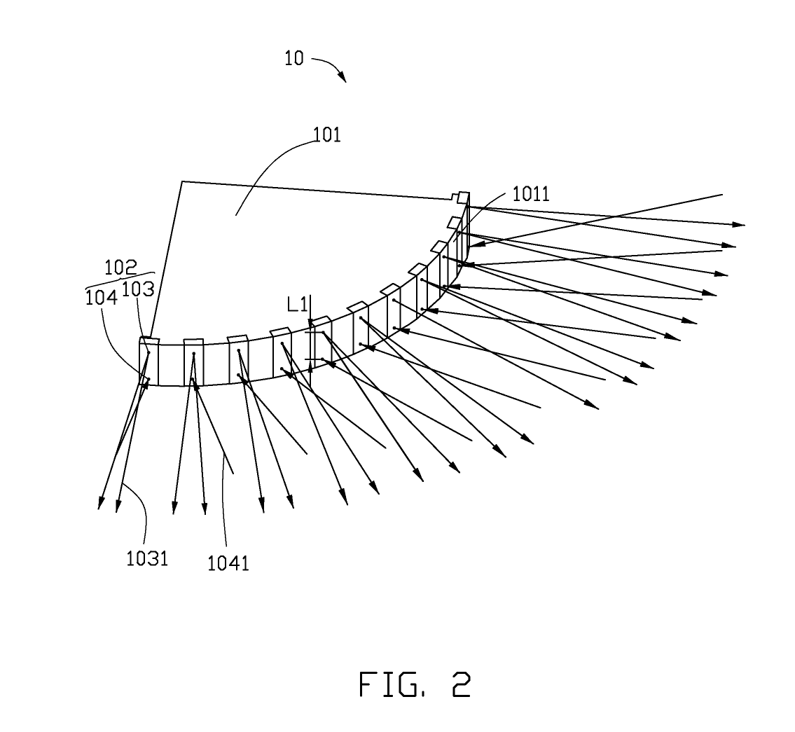

Referring to FIGS. 1-2, an electronic device 100 with touch input function includes an infrared controlling module 10, a display 20, and a processor 30. The infrared controlling module 10 is arranged in a frame 201 of the display 20. The processor 30 is connected to the infrared controlling module 10 and the display 20. In this embodiment, the infrared controlling module 10 is disposed at the top left corner of the frame 201.

In this embodiment, the infrared controlling module 10 includes a quadrant-shaped main body 101 and at least one infrared module 102 arranged at an arc sidewall 1011 of the main body 101. The sidewall 1011 is substantially perpendicular to surface of the display 20. The distance D between the center of the main body 101 and the center of the display 20, and the radius R of the main body 101 are preset in the device 100. Each infrared module 102 includes an infrared emitter 103 and an infrared receiver 104. The infrared emitter 103 and the infrared receiver 104 of each infrared module 102 are disposed together along a vertical line and are separated by a certain distance L1. The distance L1 is preset in the device 100. Each infrared emitter 103 has been configured and/or disposed to emit infrared rays 1031 in a plane perpendicular to the display 20 and the sidewall 1011 respectively. Therefore, when an object such as a finger or a stylus touches a spot of the display 20, a number of infrared rays from one infrared emitter 103 are blocked by the object, but only one reflected infrared ray 1041 transmits to the infrared receiver 104 vertically below the emitting infrared emitter 103.

In this embodiment, when the processor 30 determines that one infrared receiver 104 has received a reflected infrared ray 1041 emitted by the infrared emitter 103 of an infrared module 102 including the infrared receiver 104, the processor 30 controls the infrared emitter 103 corresponding to the infrared receiver 104 to re-emit the infrared rays 1031 after a short lapse of time of stopping emitting of infrared rays 1031, and records a duration T from the time the infrared emitter 103 re-emits the infrared rays 1031 to the time the corresponding infrared receiver 104 receives reflected one or more of the re-emitted infrared ray 1041. The processor 30 determines the touched spot according to the distance L1 and the duration T. The processor 30 can further determine which icon or symbol is displayed on the touched spot and performs an operation corresponding to that icon or symbol.

In this embodiment, the processor 30 displays visual information on the display 20. If the visual information includes at least one touch icon, the processor 30 displays each touch icon (on the display 20) in a straight line or lines immediately underneath the infrared rays 1031 from one infrared emitter 103. Thus, when the spot corresponding to one particular touch icon is touched, only the infrared receiver 104 on the same line as the infrared emitting 103 can receive the reflected infrared ray 1041, and the touched position can be determined.

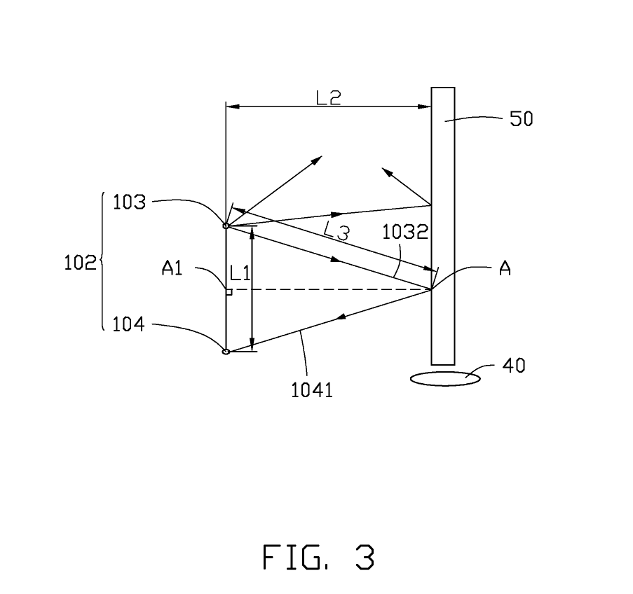

FIG. 3 is a schematic view showing how to determine a touched spot 40 of the display 20. In this embodiment, the lines of connection between the infrared emitter 103 emitting the infrared rays 1031, the infrared receiver 104 below the infrared emitter 103, and a point A on the touching object 50, cooperatively form an imaginary triangle, wherein the point A is a point from which the infrared ray 1032 is reflected back to the infrared receiver 104. The projection point of the point A projected on the display 20 will be determined as the touched spot 40. The distance L3 between the point A and the infrared receiver 104 is equal to that between the point A and the infrared emitter 103. The distance L3 is calculated according to a formula L3=v*T/2, wherein the v is the velocity of light. The distance L2 between the reflected point A and a predetermined point A1 in the middle of the emitter 103 and the receiver 104 is calculated according to a formula L2=\sqrt{L3*L3−L1*L1/4}. Thus, the processor 30 can determine the coordinates of the touched spot 40 according to the distance L2, D, and R.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. An electronic device with touch input function, comprising:
a display comprising a frame;
a processor; and
an infrared controlling module arranged in the frame, the infrared controlling module comprising:
a quadrant-shaped main body comprising an arc sidewall, the arc sidewall being substantially perpendicular to the surface of the display, a distance D between a center of the quadrant-shaped main body and a center of the display, and the radius R of the quadrant-shaped main body being preset in the electronic device; and
at least one infrared module arranged at the arc sidewall, each of the at least one infrared module comprising:
an infrared emitter and an infrared receiver disposed together along a vertical line and separated by a distance L1, the distance L1 being preset in the electronic device, the infrared emitter being configured for emitting infrared rays in a plane perpendicular to the display and the arc sidewall respectively, the infrared receiver being configured for receiving one or more of the infrared rays being blocked and reflected by an object to the infrared receiver when the object touches a spot of the display;
wherein, when the processor determines that the infrared receiver of one of the at least one infrared module has received a reflected infrared ray emitted by the infrared emitter of the infrared module, the processor controls the infrared emitter to re-emit infrared rays after a short lapse of time of stopping emitting of infrared rays, record a duration T from the time the infrared emitter re-emit the infrared rays to the time the infrared receiver receives reflected one or more of the re-emitted infrared ray, and determines a touched spot according to the distance D, the radius R, the distance L1, and the duration T.

2. The electronic device as described in claim 1, wherein the processor is further to display at least one touch icon on the display arranged in straight lines immediately underneath the emitted infrared rays from the at least one infrared module, determine which touch icon is displayed on the touched spot, and performs an operation corresponding to the determined touch icon.

3. The electronic device as described in claim 2, wherein the lines of connection between the infrared emitter emitting the infrared rays, the infrared receiver below the infrared emitter, and a point on the object cooperatively form an imaginary triangle, wherein the point is a point from which an infrared ray is reflected back to the infrared receiver, the projection point of the reflection point projected on the display is determined as the touched spot, the distance L3 between the reflecting point and the infrared receiver is equal to that between the reflecting point and the infrared emitter, the processor determines the distance L3 according to a formula L3=v*T/2 with the v is the velocity of light, determines the distance L2 between the reflected point and a point in the middle of the emitter and the receiver according to a formula L2=\sqrt{L3*L3−L1*L1/4}, and further determines the touched spot according to the distance L2, D, and R.

4. The electronic device as described in claim 1, wherein the infrared controlling module is disposed at a top left corner of the frame.
